(19) United States
(12) Patent Application Publication
(10) Pub. No.: US 2018/0375178 A1
(43) Pub. Date: Dec. 27, 2018

(54) METHOD FOR DETECTING TEMPERATURE OF BATTERY SYSTEM

(71) Applicant: SANYO Electric Co., Ltd., Osaka (JP)

(72) Inventor: YUTAKA YAMAUCHI, Hyogo (JP)

(21) Appl. No.: 15/739,836

(22) PCT Filed: Sep. 14, 2016
(86) PCT No.: PCT/JP2016/004174

§ 371 Date: Dec. 26, 2017

(30) Foreign Application Priority Data
Sep. 25, 2015 (JP) 2015-188832

(51) Int. Cl. H01M 10/48; G01K 1/14; H01M 10/44

(52) U.S. Cl. CPC H01M 10/486; H01M 10/443; G01K 1/14

(57) ABSTRACT

In order to stably reduce the level of induction noise using an inexpensive circuit configuration, reduce detection time delay, and accurately detect a battery temperature, a method has a detection step of detecting a battery temperature in a predetermined sampling period, and detecting a battery temperature change rate per unit time [(Traw−Told)/t]; and a step including, calculating the battery temperature using the change rate as an actual change rate (ΔT/Δt now) of an old change rate (ΔT/Δt old) prior to exceeding the maximum change rate (ΔT/Δt max) or a predetermined set charge rate (ΔT/Δt set), when the battery temperature change rate [(Traw−Told)/t] exceeds the maximum change rate (ΔT/Δt max), and calculating the battery temperature using the detected change rate [(Traw−Told)/t] as the battery temperature change rate, when the battery temperature change rate [(Traw−Told)/t] is less than the maximum change rate (ΔT/Δt max).

### TECHNICAL FIELD

The present invention relates to a method for detecting a temperature of a battery configuring a battery system, especially, a method for detecting a temperature to prevent erroneous detection.

### BACKGROUND ART

A battery system for a power supply device is used as a power source to drive an electric vehicle, to provide power stored from natural energy to a load, or to provide power to a load during a power failure. In these battery systems, a battery temperature changes by an external environment, for example, such as charging and discharging current, or an usage temperature. In this battery system, it is important to control charging or discharging while monitoring a temperature of the battery in a view of securing safety. In a state where the battery temperature is out of a normally usable range, the safety is not secured, and then a life of the battery is decreased due to degradation in the electrical property of the battery, and furthermore there is a possibility that smoke or ignition occurs. Also, in monitoring the safety of the battery system, when the battery temperature becomes abnormal, quick action of securing the safety, for example, turning off a relay connected to an output side, is necessary. Therefore, detection of the abnormal temperature of the battery is very important. According to these, the battery system is required to quickly, accurately detect the battery temperature.

In order to detect the battery temperature, the battery system has been developed which detects the battery temperature by a temperature sensor. (refer to Patent Literature 1)

### CITATION LIST

### Patent Literature

Patent Literature 1: Unexamined Japanese Patent Publication No. 2009-87583

### SUMMARY OF THE INVENTION

### Technical Problem

A temperature sensor such as thermistor is fixed at a surface of the battery in a thermally coupled state, and the temperature sensor and a detection circuit are connected by a lead wire, and then the battery temperature is detected from an electric resistance of the thermistor by the detection circuit. In the battery system having this circuit configuration, the temperature sensor is disposed at an optimal location for detecting the temperature, and electrical components are installed at a circuit board.

Since the detection circuit is disposed at an optimal location of the circuit board, the temperature sensor and the circuit board are separately disposed. Therefore, it is necessary to connect both of them by a lead wire. As the temperature sensor and the circuit board are connected by the lead wire, a noise is induced at the lead wire, and then error in the detected temperature occurs due to the induced noise. This noise is induced from the inside of the battery system, and also is induced from a system to which the battery system provides power, and then the induced noise of the lead wire cannot be completely prevented. Completely shielding the lead wire is effective in reducing the induced noise. However, the induced noise cannot be completely removed by this way. Further, as the noise is also induced at the temperature sensor, even though the lead wire is completely shielded, a signal inputted from the temperature sensor to the detection circuit, includes the induced noise.

The induced noise of the lead wire can be reduced by an analog noise filter as a high-cut filter, which is configured of capacitors or coils and is provided at the input side of the detection circuit. The frequency of the frequency component of the noise is higher than that of the temperature change. Here, the analog noise filter realizes idealistic frequency response characteristics to effectively attenuate noise component. The more effectively the analog noise filter removes noise component, the higher component cost becomes. Further, when the analog noise filter is provided at the input side of the detection circuit, a delay in detection of the battery temperature may occur due to phase shift. Especially, when the analog noise filter has sharp attenuation characteristics, the phase shift is large, and then there is a problem that the delay of the detection becomes large.

The present invention has been accomplished to solve such a problem. An important object of the present invention is to supply a method for detecting a temperature of a battery system which can stably reduce the level of induction noise using an inexpensive circuit configuration without using a lot of components, and can reduce detection time delay, and can accurately detect battery temperature.

### Solution to Problem and Advantageous Effect of Invention

A method of detecting a temperature of the present invention, includes a detection step, and a temperature determining step to detect a temperature of a battery. The detection step is to detect a battery temperature of the battery system in a predetermined sampling period, and detect a battery temperature change rate per unit time [(Traw−Told)/t]. The temperature determining step, while the battery temperature change rate [(Traw−Told)/t] which is detected in the detection step, is compared with a predetermined maximum change rate (ΔT/Δt max), includes: calculating the battery temperature using the change rate as an actual change rate (ΔT/Δt now) of an old change rate (ΔT/Δt old) prior to exceeding the maximum change rate (ΔT/Δt max) or a predetermined set charge rate (ΔT/Δt set), when the battery temperature change rate [(Traw−Told)/t] exceeds the maximum change rate (ΔT/Δt max); and calculating the battery temperature using the detected change rate [(Traw−Told)/t] as the battery temperature change rate, when the battery temperature change rate [(Traw−Told)/t] is less than the maximum change rate (ΔT/Δt max).

Here, Traw is a detection value of the battery temperature at the present time, and Told is a detection value of the battery temperature prior to the detection of Traw.

The above-mentioned method of detecting the temperature of the battery system can surely reduce the level of induction noise using an inexpensive circuit configuration, reduce detection time delay of a battery temperature, without an analog filter using a large number of electric components such as coils or capacitors. It is the following reason. Instead of attenuating the noise by the analog filter, while the detected battery temperature change rate [(Traw−Told)/t] is compared with the predetermined maximum change rate (ΔT/Δt max), the above-mentioned method of detecting the temperature, specifies the battery temperature, such that the battery temperature changes at the old change rate (ΔT/Δt old) or the predetermined set charge rate (ΔT/Δt set), when the change rate [(Traw−Told)/t] exceeds the maximum change rate (ΔT/Δt max).

The increasing change rate of the battery temperature is specified by internal heat generation amount and heat capacity itself. When the heat generation is large, a gradient of the temperature increase is large. When the heat capacity is large, a gradient of the temperature increase is small. The heat generation of the battery is specified by a flowing current, a maximum current of the battery is specified by a connected load, and the heat capacity of the battery is specified by the weight and the specific heat of the battery. Therefore, the maximum value of the increasing change rate of the battery temperature, is specified by the load connected to the battery system, the weight of the battery, and the like. Then, the change rate does not exceed the maximum value. In contrast, since the noise includes a very wide frequency component, the change rate of the noise may exceed the change rate of the battery temperature. In the present invention, while the detected battery temperature change rate [(Traw−Told)/t] is compared with the maximum change rate (ΔT/Δt max), when the change rate exceeds the maximum change rate (ΔT/Δt max), it is determined that such a change rate is caused by the noise. Then, the battery temperature is specified by the actual change rate (ΔT/Δt now). Accordingly, in a state where the noise exceeding the maximum change rate (ΔT/Δt max) is induced at a detecting line of the battery temperature, the battery temperature can be accurately detected without the influence of the noise.

FIG. 4 shows that the method of detecting the temperature of the present invention effectively removes the level of the induction noise.

Curves A to C in this figure show the following waveforms.

Curve A: inputted noise waveform

Curve B: waveform after passing through the analog filter

Curve C: temperature characteristics corrected by the method of detecting the temperature of the present invention

The detection waveform for detecting the battery temperature of the battery system, shown as the curve A in this figure, includes a noise of a rectangular waveform. In the rectangular wave of the noise, a width of time is 300 msec, and a temperature change is from 25° C. to 35° C.

As shown in this figure, the way by the conventional analog filter shows the characteristics of the curve B in which a change of the waveform after passing through the analog filter is slow. The analog filter makes a sharp waveform change a slow waveform change, but cannot cut a peak value. The waveform change after passing through the analog filter becomes similar to detected temperature waveform, and then the analog filter cannot effectively cut all of noises. The change value of the detection temperature after passing through the analog filter is specified by the cut-off frequency and the attenuation characteristics. When the cut-off frequency is made low and the attenuation characteristics is made sharp, the attenuate of the noise can be made large. However, when the cut-off frequency is made low, a rapid temperature change cannot be detected. Further, since a coil having a large inductance and a capacitor having a large capacitance are used, the component cost becomes high. In addition, the analog filter having the large attenuation characteristics, uses a large number of coils and capacitors, and then the component cost is increased. Furthermore, since the phase is shifted at near the cut-off frequency, a delay in detection of the battery temperature may become large due to the phase shift. Accordingly, even though the analog filter removes a specific noise having a narrow pulse width, the analog filter cannot effectively remove many kinds of noises. As mentioned above, since the phase shift characteristics is specified by the frequency characteristics, the phase shift cannot be completely prevented in the frequency characteristics where the noise level is removed, in principle. Thus, in the conventional way where the induction noise level is decreased by the analog filter, a delay in detection of the battery temperature cannot be resolved in principle.

FIG. 5 is a graph showing a delay of measuring. In this figure, the curve A shows the characteristics where the battery temperature changes with time, the curve B shows the characteristics where the temperature is detected by removing noises by the analog filter, and the curve C shows the characteristics where the battery temperature is detected by the method of the present invention. As shown in this figure, a delay in the detection of the temperature occurs in the way of using the analog filter, but no delay in the detection of the temperature occurs in the method of the present invention.

As show in the curve C of FIG. 4, the method of detecting the temperature of the present invention can effectively remove the detected noise, and especially can cut a peak value of the noise, and then can reduce the noise level. It is the following reason. In the method of detecting the temperature of the present invention, in a state where the change rate exceeds the predetermined value, it is determined that such a change rate is caused by the noise. Then, the battery temperature is calculated using the actual change rate (ΔT/Δt now) of the old change rate (ΔT/Δt old) or the predetermined set charge rate (ΔT/Δt set). Also, the method of detecting the temperature of the present invention can reduce detection time delay in the battery temperature change, and can accurately detect a battery temperature change without the phase shift by the analog filter.

According to the method of detecting the temperature of the present invention, the old change rate (ΔT/Δt old) is an averaged change rate (ΔT/Δt mean) of the change rate values prior to exceeding the maximum change rate (ΔT/Δt max).

In the above method of detecting the temperature, since the old change rate (ΔT/Δt old) is determined as the averaged change rate (ΔT/Δt mean) of the change rate values prior to exceeding the maximum change rate (ΔT/Δt max), the battery temperature can be more accurately specified from the change rate prior to exceeding the maximum change rate (ΔT/Δt max).

According to the method of detecting the temperature of the present invention, the set charge rate (ΔT/Δt set) is set at 10% or more, and less than 50% of the maximum change rate (ΔT/Δt max).

According to the method of detecting the temperature of the present invention, wherein the predetermined sampling period is 100 μsec or more, and 500 msec or less.

According to the method of detecting the temperature of the present invention, the maximum change rate (ΔT/Δt max) is 0.2° C./sec or more, and 5° C./sec or less.

According to the method of detecting the temperature of the present invention, the predetermined maximum change rate (ΔT/Δt max) has a temperature increasing maximum change rate (ΔT/Δt max) at a time of temperature increasing, or a temperature decreasing maximum change rate (ΔT/Δt max) at a time of temperature decreasing.

The above method of detecting the temperature can surely reduce the noise in both of increasing and decreasing states of the battery temperature.

According to the method of detecting the temperature of the present invention, when the battery temperature change rate is detected using the battery system at a maximum load, the maximum change rate (ΔT/Δt max) is set at a range of ±100% of the battery temperature change rate at the maximum load.

### BRIEF DESCRIPTION OF DRAWINGS

FIG. 1 is a block diagram of a battery system used in a method of detecting a temperature of the present invention.

FIG. 2 is a graph showing a battery temperature detected in a constant sampling period or change rate of the battery temperature.

FIG. 3 is a flow chart in which a calculation circuit detects the battery temperature.

FIG. 4 is a graph showing a state where a level of an induction noise is removed in the method of detecting the temperature of the present invention.

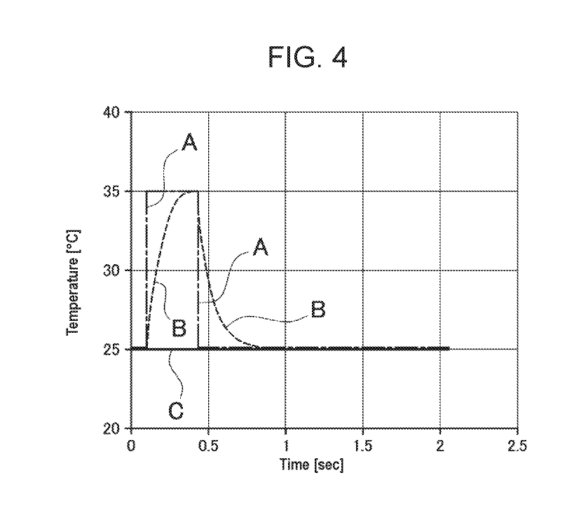

FIG. 5 is a graph showing a delay of measuring.

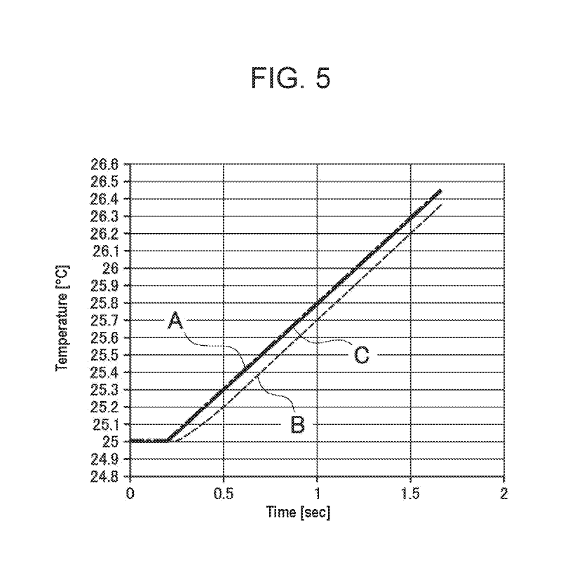

### DESCRIPTION OF EMBODIMENT

Exemplary embodiments and examples of the present invention have been described with reference to the drawings. The exemplary embodiments and examples show a method of detecting a temperature for embodying the technical ideas of the present invention. The method of detecting the temperature of the present invention is not limited to the following. In the present description, in order to easily understand the scope of claims, the corresponding numbers to members shown in the exemplary embodiments and the examples are added to members shown in the scope of claims and solution of problem. In the present description, members shown in the scope of claims are not limited to the members of the exemplary embodiments and the examples.

Furthermore, concrete exemplary embodiments and examples are explained in detail in the following with reference to the drawings.

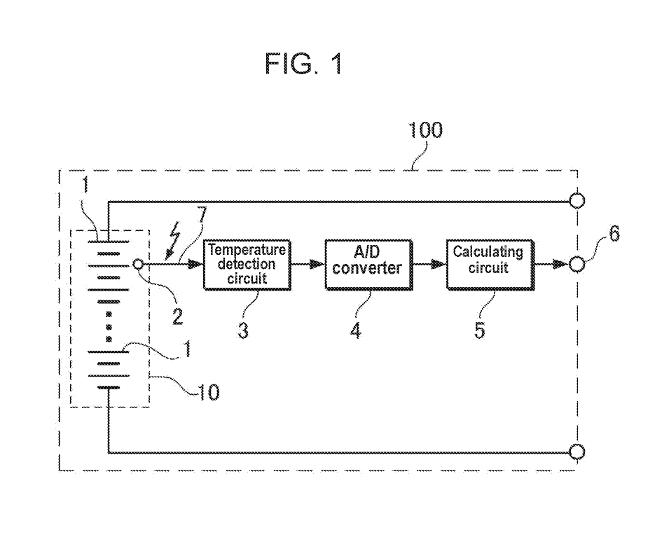

Battery system 100 of FIG. 1 includes: assembled battery 10 having a plurality of rechargeable batteries 1; temperature sensor 2 which detects a temperature of batteries 1 constituting assembled battery 10; temperature detection circuit 3 which converts an input signal such as electric resistance of temperature sensor 2 into a voltage signal; A/D converter 4 which converts an analog signal outputted from this temperature detection circuit 3 into a digital signal; and calculating circuit 5 which calculates an output signal from A/D converter 4 to output a signal of the battery temperature from temperature terminal 6.

In the battery system of FIG. 1, one temperature sensor 2 detects a specific battery temperature. Alternatively, the battery system can estimate the temperature of all batteries, by, for example, detecting all of battery temperatures through a plurality of temperature sensors, detecting only a specific battery temperature such as a highest battery temperature, a lowest battery temperature, or an average battery temperature.

The battery system is used in many kinds of usages. For example, the battery system is installed in a vehicle to provide power to a driving motor, or the battery system is used in a power source storing natural energy or supplying power at power failure as uninterruptible power supply. It is important to accurately detect a temperature of battery 1 in all usages. It is a reason why a current of charging or discharging is controlled based on the battery temperature to protect battery 1, or a remaining capacity is calculated. It is important to decrease the noise level in accurate temperature detection. It is a reason why the noise causes error in detected battery temperature.

In the temperature detection, the noise is induced in a detection signal due to various causes. Temperature sensor 2 detects a temperature of battery 1 in a thermally coupled state where temperature sensor 2 is disposed to battery 1, and then temperature sensor 2 converts the battery temperature into an electric resistance to transmit it to temperature detection circuit 3. For example, the noise is induced in lead wire 7 of temperature sensor 2 from outside. Further, a noise of a power source circuit is inputted in all circuits, and it causes detection error. Temperature detection circuit 3 converts a signal inputted from temperature sensor 2 into an analog signal to output. Temperature detection circuit 3, for example, outputs a voltage signal as an analog signal proportional to a temperature. However, a temperature signal including a noise is inputted from temperature sensor 2 into temperature detection circuit 3, and also a noise is inputted from the power source circuit

An output from temperature detection circuit 3 is inputted into A/D converter 4. A/D converter 4 converts analog signals inputted in a predetermined sampling period into digital signals to output. Accordingly, digital signals outputted from A/D converter 4 are temperature signals of battery 1, including noises. Calculating circuit 5 removes noises from temperature signals inputted from A/D converter 4, and outputs accurate temperature signal from temperature terminal 6 to outside.

Calculating circuit 5 detects a temperature of battery 1, while removing noise influence, by the following steps.

### (Detection Step)

In this step, in battery system 100, A/D converter 4 detects a battery temperature in a predetermined sampling period, and outputs to calculating circuit 5. Calculating circuit 5 calculates a battery temperature change rate per unit time [(Traw−Told)/t]. A/D converter 4 converts the analog signals inputted from temperature detection circuit 3 into the digital signals, and then outputs the digital signals to calculating circuit 5 in the predetermined sampling period, for example, 100 μsec or more and 1 sec or less, preferably 1 msec or more and 500 msec or less, more preferably 2 msec or more and 200 msec or less.

When the sampling period is set at a short time, A/D converter 4 can detect a rapid temperature change of battery 1. However, since the temperature change of battery 1 is specified by heat capacity, heat generation amount or heat radiation amount, the sampling period is set at the optimal value within the above-mentioned range, considering the temperature change.

Calculating circuit 5 subtracts a previous detection value (Told) of the battery temperature from a present detection value (Traw) of the battery temperature, and further calculates a battery temperature change rate per unit time [(Traw−Told)/t].

### (Temperature Determining Step)

In this step, calculating circuit 5 compares the battery temperature change rate [(Traw−Told)/t] which is detected in the detection step, with a predetermined maximum change rate (ΔT/Δt max). The predetermined maximum change rate (ΔT/Δt max) is specified from a maximum temperature increasing rate in a state where the battery system charges or discharges with a maximum current. The predetermined maximum change rate (ΔT/Δt max) is set, for example, at 100% or more and 200% or less, or preferably 100% or more and 150% or less of the maximum temperature increasing rate in a use state.

Also, when the battery temperature change rate is detected using the battery system at a maximum load, the maximum change rate (ΔT/Δt max) is set at a range of ±100% of the battery temperature change rate at the maximum load. Further, for example, the maximum change rate (ΔT/Δt max) can be set at 0.2° C./sec or more and 5° C./sec or less.

While the battery temperature change rate [(Traw−Told)/t] which is detected in the detection step, is compared with the predetermined maximum change rate (ΔT/Δt max), calculating circuit 5 calculates the battery temperature using the change rate as an actual change rate (ΔT/Δt now) of an old change rate (ΔT/Δt old) prior to exceeding the maximum change rate (ΔT/Δt max) or a predetermined set charge rate (ΔT/Δt set), when the battery temperature change rate [(Traw−Told)/t] exceeds the maximum change rate (ΔT/Δt max); and

The temperature of the battery system is increased due to internal heat generation, and then the temperature is decreased by cutting off the current in a heated state at high temperature. The change rates (ΔT/Δt) of the battery temperature at times of temperature increase due to heat generation and temperature decrease, are not necessarily the same. In a normal use, the change rates (ΔT/Δt) of the temperature increase in a state of charging or discharging with a maximum current is larger than the change rates (ΔT/Δt) of the temperature decrease in a cooling state after cutting off the current at the maximum temperature. Therefore, when the maximum change rate (ΔT/Δt max) is set at a change rate (ΔT/Δt) of the temperature increase in the state of charging or discharging with the maximum current or more, a change rate (ΔT/Δt) in states of the temperature increase and decrease, does not exceed the predetermined maximum change rate (ΔT/Δt max). Accordingly, the method of detecting the temperature of the present invention, can remove noises while compared with the maximum change rate (ΔT/Δt max) in both of the states of the temperature increase and decrease. Alternatively, in the method of detecting the temperature of the present invention, the maximum change rate (ΔT/Δt max) in the state of the temperature increase can be set at a different value from the maximum change rate (ΔT/Δt max) in the state of the temperature decrease. According to this way, the battery temperature in the state of the temperature decrease can be more accurately detected. It is the following reason. Since the battery temperature change rate [(Traw−Told)/t] is compared with the small predetermined maximum change rate (ΔT/Δt max) in the state of the temperature decrease, the smaller level of the noise can be determined as a noise, and then can be removed. Here, the change rate (ΔT/Δt) in the state of the temperature decrease is actually a negative value, and then an absolute value of the change rate (ΔT/Δt) is compared with an absolute value of the maximum change rate (ΔT/Δt max).

When the battery temperature change rate [(Traw−Told)/t] exceeds the maximum change rate (ΔT/Δt max), calculating circuit 5 calculates the battery temperature using the battery change rate of battery 1 as an actual change rate (ΔT/Δt now). The actual change rate (ΔT/Δt now) is an old change rate (ΔT/Δt old) or a predetermined set charge rate (ΔT/Δt set). The old change rate (ΔT/Δt old) is calculated from the battery temperature change rate before the battery temperature change rate of battery 1 exceeds the maximum change rate (ΔT/Δt max).

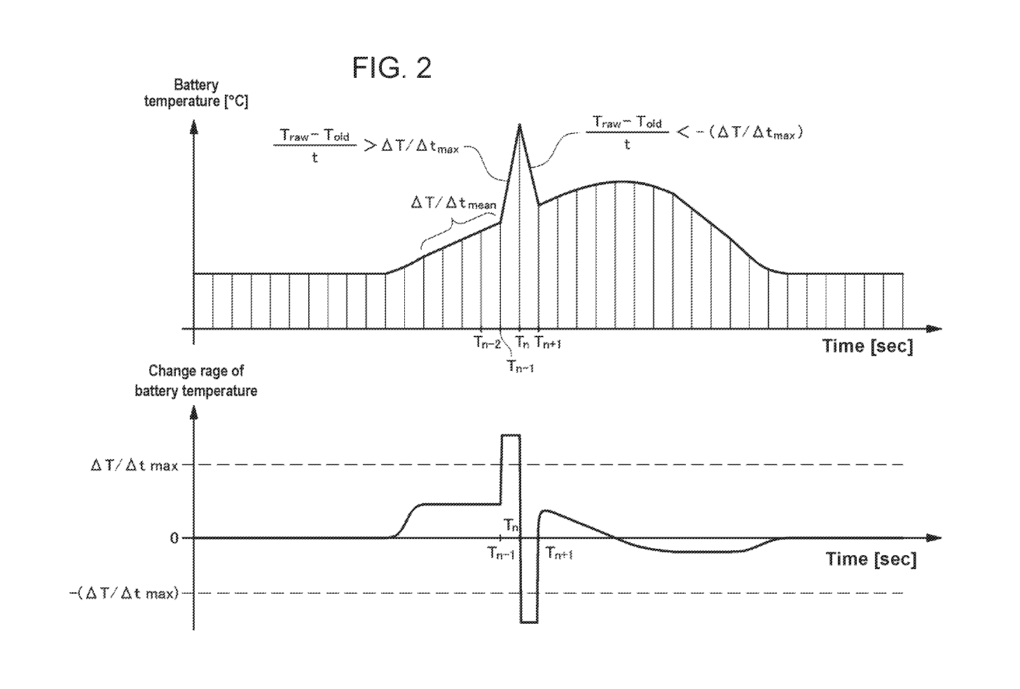

FIG. 2 shows a state where the battery temperature detected in a predetermined sampling period changes, namely, the detected temperature signal inputted from A/D converter 4 to calculating circuit 5 and the change rate per unit time (ΔT/Δt) in this battery temperature change. The detected temperature signal of FIG. 2 shows a steep peak value due to the influence of the inducted noise at a time of Tn. Accordingly, the detected battery temperature change rate [(Traw−Told)/t] exceeds the maximum change rate (ΔT/Δt max) at the time of Tn. The old change rate (ΔT/Δt old) is calculated from the battery temperature change rate before the battery temperature change rate of battery 1 exceeds the maximum change rate (ΔT/Δt max). Accordingly, calculating circuit 5 calculates the old change rate (ΔT/Δt old) prior to Tn from the battery temperature of time Tn−1 and the battery temperature of time Tn−2. Namely, calculating circuit 5 calculates the old change rate (ΔT/Δt old) by the following expression.

[(battery temperature of time Tn−1)−(battery temperature of time Tn−2)]/time

Further, as shown in FIG. 2, calculating circuit 5 can also calculate an averaged change rate (ΔT/Δt mean) that the battery temperature change rates at plural times are averaged, as the old change rate (ΔT/Δt old). In the way of calculating the old change rate (ΔT/Δt old) from the averaged value, a number of the times for calculating the averaged value is specified, considering the sampling period of A/D converter 4 and gradients of the battery temperature change. The number of the times for calculating the averaged value is preferably 3 or more and 100 or less. For example, when the averaged change rate (ΔT/Δt mean) is calculated from the sampling period of 100 msec and the averaged value of the detected temperatures of the 10 times prior to exceeding the maximum change rate (ΔT/Δt max), the averaged value during 1 sec prior to exceeding the maximum change rate (ΔT/Δt max) can be calculated as the old change rate (ΔT/Δt old).

The set charge rate (ΔT/Δt set) is set at a value smaller than the maximum change rate (ΔT/Δt max), and is set at an averaged value in a state where the temperature of battery 1 changes, for example, 10% or more and less than 50% of the maximum change rate (ΔT/Δt max).

Calculating circuit 5 calculates the battery temperature using the detected change rate [(Traw−Told)/t] as the battery temperature change rate of battery 1, when the battery temperature change rate [(Traw−Told)/t] is less than the maximum change rate (ΔT/Δt max), determining that there is no influence of the noise.

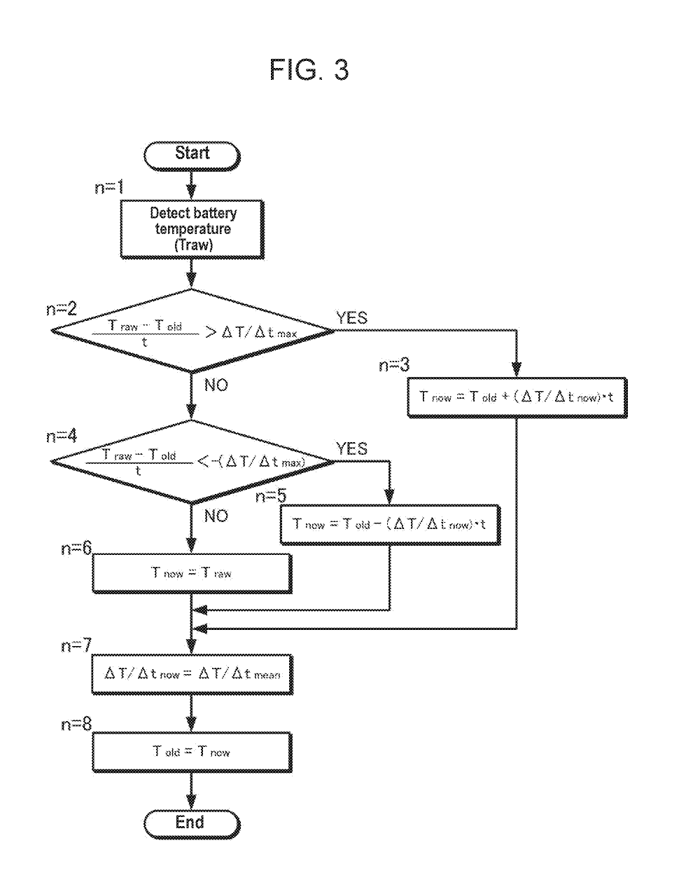

Calculating circuit 5 accurately detects the battery temperature, while preventing noise influence, by the following flow chart shown in FIG. 3.

### (Detection Step of Battery Temperature)

(Step 1 n=1)

In this step, A/D converter 4 outputs digital signals corresponding to temperature to calculating circuit 5 in the predetermined sampling period, from inputted analog signals. Calculating circuit 5 detects the battery temperature (Traw) at the present time, from inputted signals from A/D converter 4.

### (Temperature Determining Step)

(Step 2 n=2)

In this step, a determination is made as to whether an increasing battery temperature change rate exceeds the maximum change rate. In order to realize this, calculating circuit 5 subtracts a previously detected battery temperature (Told) from a presently detected battery temperature (Traw), and further calculates a battery temperature change rate per unit time [(Traw−Told)/t] from temperature difference. Further, calculating circuit 5 determines whether a change rate [(Traw−Told)/t] is bigger than the maximum change rate (ΔT/Δt max).

(Step 3 n=3)

When it is determined that a change rate [(Traw−Told)/t] is bigger than the maximum change rate (ΔT/Δt max), calculating circuit 5 adds a temperature change calculated from an actual change rate (ΔT/Δt now), to a previously detected battery temperature (Told), and thereby calculates a present temperature (Tnow) of battery 1.

The actual change rate (ΔT/Δt now) is, for example, is an averaged change rate (ΔT/Δt mean) of the 100 times prior to exceeding the maximum change rate (ΔT/Δt max), as an old change rate (ΔT/Δt old).

(Step 4 n=4)

In this step, a determination is made as to whether a decreasing battery temperature change rate exceeds the maximum change rate.

When the decreasing battery temperature change rate exceeds the maximum change rate, the change rate [(Traw−Told)/t] becomes a negative value, and then the absolute value of the negative value exceeds the absolute value of the maximum change rate (ΔT/Δt max). Accordingly, since the absolute value of the change rate [(Traw−Told)/t] of the decreasing battery temperature exceeds the maximum change rate (ΔT/Δt max), the expression is [(Traw−Told)/t]<−(ΔT/Δt max).

Namely, in this step, when the change rate [(Traw−Told)/t] of the battery temperature is smaller than the negative maximum change rate (−ΔT/Δt max), calculating circuit 5 determines that the change rate exceeds the maximum change rate.

(Step 5 n=5)

When it is determined that the change rate [(Traw−Told)/t] of the decreasing battery temperature is smaller than the negative maximum change rate−(ΔT/Δt max), namely, the absolute value of the change rate [(Traw−Told)/t] of the decreasing battery temperature is bigger than the maximum change rate (ΔT/Δt max), calculating circuit 5 subtracts a temperature change calculated from an actual change rate (ΔT/Δt now), from a previously detected battery temperature (Told), and thereby calculates a present temperature (Tnow) of battery 1.

Also, in this step, the actual change rate (ΔT/Δt now) is, preferably, an averaged change rate (ΔT/Δt mean) prior to exceeding the maximum change rate (ΔT/Δt max), as an old change rate (ΔT/Δt old).

(Step 6 n=6)

In a state where both of the increasing battery temperature change rate and the decreasing battery temperature rate do not exceed the maximum change rate, in this step, calculating circuit 5 regards a present temperature (Tnow) of battery 1 as the battery temperature (Traw) at the present time.

(Step 7 n=7)

In this step, calculating circuit 5 calculates an actual change rate (ΔT/Δt now). In this step, an actual change rate (ΔT/Δt now) is calculated as an old change rate (ΔT/Δt old).

The old change rate (ΔT/Δt old) is calculated by the expression of [present temperature (Tnow)−previously detected battery temperature (Told)]/t.

Calculating circuit 5 calculate an averaged change rate (ΔT/Δt mean) that the battery temperature change rates at plural times are averaged, as the old change rate (ΔT/Δt old). The number of the times for calculating the averaged value is specified considering the sampling period, for example, 3 or more and 100 or less. Calculating circuit 5 calculates the averaged change rate (ΔT/Δt mean), for example, from the sampling period of 100 msec and the averaged value of the detected change rates of the 10 times. Calculating circuit 5 regards the old change rate (ΔT/Δt old) of the calculated averaged change rate (ΔT/Δt mean) as the actual change rate (ΔT/Δt now).

(Step 8 n=8)

In this step, the present temperature (Tnow) is made a previously detected battery temperature (Told) which will be used in Step 2. Then, Steps 1 to 8 are repeated, and a varying present temperature (Tnow) of battery 1 is detected.

### INDUSTRIAL APPLICABILITY

The present invention is used in a battery system which prevents noise influence and accurately detects a battery temperature, for example, a battery system including a power supply device for a vehicle receiving big external noise.

### REFERENCE MARKS IN THE DRAWINGS

100 battery system
1 battery
2 temperature sensor
3 temperature detection circuit
4 A/D converter
5 calculating circuit
6 temperature terminal
7 lead wire
10 assembled battery

1. A method of detecting a temperature of a battery system, comprising:
a detection step of detecting a battery temperature of the battery system in a predetermined sampling period, and detecting a battery temperature change rate per unit time [(Traw−Told)/t]; and
a temperature determining step, while the battery temperature change rate [(Traw−Told)/t] which is detected in the detection step, is compared with a predetermined maximum change rate (ΔT/Δt max), including:
calculating the battery temperature using the change rate as an actual change rate (ΔT/Δt now) of an old change rate (ΔT/Δt old) prior to exceeding the maximum change rate (ΔT/Δt max) or a predetermined set charge rate (ΔT/Δt set), when the battery temperature change rate [(Traw−Told)/t] exceeds the maximum change rate (ΔT/Δt max); and
calculating the battery temperature using the detected change rate [(Traw−Told)/t] as the battery temperature change rate, when the battery temperature change rate [(Traw−Told)/t] is less than the maximum change rate (ΔT/Δt max)

2. The method of detecting the temperature of the battery system according to claim 1, wherein the old change rate (ΔT/Δt old) is an averaged change rate (ΔT/Δt mean) of the change rate values prior to exceeding the maximum change rate (ΔT/Δt max).

3. The method of detecting the temperature of the battery system according to claim 1, wherein the set charge rate (ΔT/Δt set) is set at 10% or more, and less than 50% of the maximum change rate (ΔT/Δt max).

4. The method of detecting the temperature of the battery system according to claim 1,
wherein the predetermined sampling period is 100 sec or more, and 500 msec or less.

5. The method of detecting the temperature of the battery system according to claim 1,
wherein the maximum change rate (ΔT/Δt max) is 0.2° C./sec or more, and 5° C./sec or less.

6. The method of detecting the temperature of the battery system according to claim 1,
wherein the predetermined maximum change rate (ΔT/Δt max) has a temperature increasing maximum change rate (ΔT/Δt max) at a time of temperature increasing, or a temperature decreasing maximum change rate (ΔT/Δt max) at a time of temperature decreasing.

7. The method of detecting the temperature of the battery system according to claim 1,
wherein when the battery temperature change rate is detected using the battery system at a maximum load, the maximum change rate (ΔT/Δt max) is set at a range of ±100% of the battery temperature change rate at the maximum load.
